(19) United States
(12) Patent Application Publication
(10) Pub. No.: US 2007/0199355 A1
(43) Pub. Date: Aug. 30, 2007

(54) Actuating Module For A Motor Vehicle

(76) Inventor: Andreas Feigl, Bad Abbach (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 10/599,888

(22) PCT Filed: Apr. 12, 2005
(86) PCT No.: PCT/EP05/51602

§ 371 Date: Oct. 12, 2006

(30) Foreign Application Priority Data
Apr. 14, 2004 (DE) 10 2004 018 164.0

(51) Int. Cl. B60R 25/02

(52) U.S. Cl. 70/252

(57) ABSTRACT

An actuating module for a motor vehicle, has a housing (12); a manually-activatable actuation component (14) accommodated in the housing to allow movement, which is embodied as a pushbutton on which a grip element (26) is embodied as the actuation surface, and at least one operating switch (28), with which an operating function of the motor vehicle can be switched by actuating the actuation component (14); whereby the actuation component (14) features a slot (18) for insertion of an electronic identification transmitter (20), on which identification data is stored, through the interrogation of which an authorization for switching the operating switch can be established and the switch is able to be switched to a ready state if the authorization is positive, and whereby the actuation component (14) features a grip element (26) by means of which it can be actuated without an identification transmitter (20) inserted into the slot.

### CROSS-REFERENCE TO RELATED APPLICATIONS

This application is a U.S. national stage application of International Application No. PCT/EP2005/051602 filed Apr. 12, 2005, which designates the United States of America, and claims priority to German application number DE 10 2004 018 164.0 filed Apr. 14, 2004, the contents of which are hereby incorporated by reference in their entirety.

### TECHNICAL FIELD

The invention relates to an actuating module for a motor vehicle.

### BACKGROUND

A generic actuating module is for example known from DE 3436761 C2. The housing of the actuating module is embodied as a mounting sleeve arranged in the dashboard on which operating switches are arranged. A rotatable actuating part embodied as a barrel is arranged in the mounting sleeve which has mechanical stops for actuating the operating switches. The barrel further contains a slot for introducing the identification generator which contains a transmitter. At the end of the slot a receiver is provided for the signals of the transmitter. The identification transmitter can only be introduced into the barrel when the latter is in a predefined position. After insertion of the identification transmitter a check is made as to whether this carries data authorizing the use of the vehicle. If it does, when the barrel is turned the actuated operating switches can actuate the functions assigned to them, for example switch on the ignition, put an injection pump into operation etc.

A peculiarity of the known actuating module lies in the fact that the barrel is turned with the aid of the identification transmitter pushed into the slot and the operating switches are switched in this manner. Furthermore the actuating module is only capable of functioning if the identification transmitter is located in the slot.

In addition an actuating module for a motor vehicle is known from publication DE 10 2004 013 198 A1 containing a housing which can preferably be mounted in a dashboard, a manually-activatable actuation component accommodated to allow movement in the housing and at least one operating switch, with which an operating function of the motor vehicle can be switched by actuating the actuation component. The actuation component features a slot for insertion of an electronic identification transmitter, on which identification data is stored, through the interrogation of which an authorization for switching the operating switch can be established. The switch can be switched to ready by a positive authorization, whereby the actuation component features a grip element by means of which it can be actuated without an identification transmitter inserted into the slot.

Reference is also made to DE 199 39 733 C2; EP 1 279 576 A2; EP 1 026 054 A1 and US 2001/0011942 A1.

### SUMMARY

The object of the invention is to specify an improved actuating module compared to the prior art, with which a greater flexibility in use can be achieved in particular.

This object can be achieved by an actuating module for a motor vehicle, comprising a housing, a movably-supported actuation component within a frontal opening of the housing, which can be moved manually by means a front actuation surface serving as a grip element against an opposing force from a rest position into the housing, and after activation of at least one operating switch for a corresponding operating function returns to its rest position, wherein the actuation component comprises a slot for insertion of an electronic identification device and the actuation component can also be moved without the identification device being inserted, and wherein the actuation component consists of two part components which fit inside each other, of which one has the slot for the identification device and is mechanically coupled with the other subcomponent embodied as a switching component such that the other part component can be moved independently of the one part component by means of the actuation surface serving as a grip element.

The at least one operating switch can be switched by each of the two subcomponents. Different operating switches can be switched with the two subcomponents. The operating switch can be activated by interrogating the identification data for an identification device located outside the slot. The actuating module may feature an electronic communication unit for interrogating identification data elements when an identification device is inserted into the slot. The operating switch can be an engine start/stop switch.

The inventive actuating module can be used for systems in which the identification transmitter is only read out or the actuation authorization is only checked if the identification transmitter is inserted into the slot of the actuation component. It can also be used in systems in which the identification transmitter is being carried on the clothing or in the bag of a person operating the motor vehicle and is read out by a communication system with a sufficiently long range, as is the case with the PASE (Passive Safety Entry) system. The actuation component can be actuated independently of the identification transmitter inserted into its slot.

The inventive actuating module can thus advantageously be used for different systems, making it possible to reduce the diversity of parts involved.

### BRIEF DESCRIPTION OF THE DRAWINGS

The invention is explained below with reference to schematic diagrams giving examples and with further details. The Figures show:

FIG. 1 a cross-section through a actuating module;

FIG. 2 a section from the actuation module according to FIG. 1 with the actuation component actuated;

FIG. 3 a view of from the right in accordance with FIG. 1 of the actuation module shown in FIG. 1; and

FIGS. 4 to 6 views similar to FIG. 2 of a modified embodiment of an actuation module in different operating states.

### DETAILED DESCRIPTION

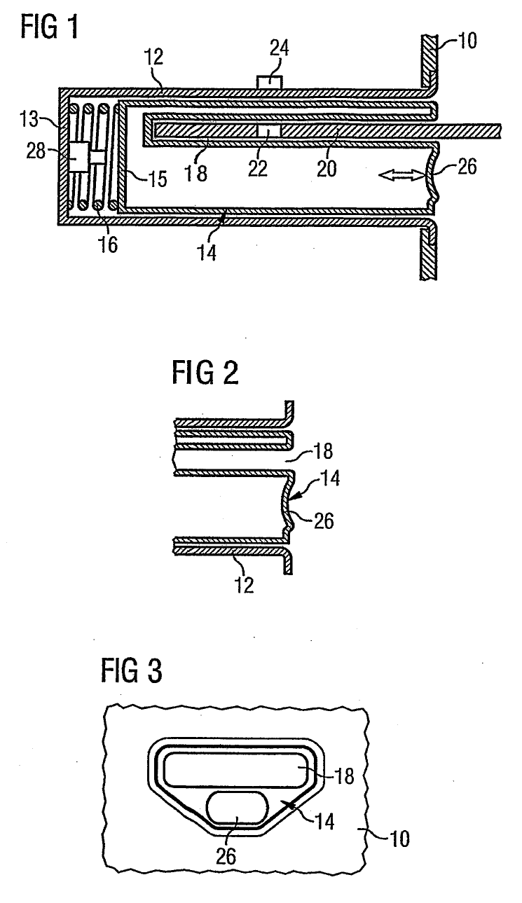

According to FIGS. 1 to 3, a housing 12 is fitted into a dashboard 10 and according to FIG. 1 is open on the right and ends in an end wall 13 on the left. An actuation component 14 embodied with a corresponding cross-section is inserted into the housing 12, which in the example shown, as can be seen from FIG. 3, has an overall triangular-shaped cross section with rounded corners. The actuation component 14 can be pushed into the housing 12 from its rest position as shown in FIG. 1 into a position as shown in FIG. 2 in which it is in its turn retained by means of a latch and from which the actuation component 14 can be returned by pushing it further into the position depicted in FIG. 1. Advantageously a spring 16 is arranged between an end wall 15 of the actuation component 14 and the end wall 13 of the housing 12. Alternatively the latching of the position of the actuation component 14 as shown in FIG. 2 can be omitted and the actuation component 14 can only be pushed from the position shown in FIG. 1 into the housing, in which case it automatically returns to the rest position.

A slot 18 for accepting an identification transmitter 20 is embodied in the actuation component 14. The identification transmitter 20 is for example embodied in the form of a key with an simple shaft and features an electronic unit 22 which contains a data memory, a transmitter/receiver, an energy supply etc. and for example is embodied overall as a transponder, in which case the energy for the energy supply unit of the electronic unit 22 can be fed in wirelessly from outside.

For communication with the electronic unit 22 a transceiver unit 24 is provided which is preferably accommodated on the housing 12.

As can be seen from FIG. 1, in addition to the slot, the right-hand side of the actuation component 14 is embodied with an indentation or a contour, which forms the grip element 26 for direct manual actuation of the actuation component 14.

Between the end wall 13 of the housing 12 and the end wall 15 of the actuation component 14 a switch 28 is arranged, with which, by pressing the actuation component 14 into the housing 12, which can be done by means of the Identification transmitter 20 or directly by pushing on the grip element 26, an operating function of the motor vehicle, for example starting the engine and/or stopping the engine can be switched. Of course, especially for redundancy reasons, a number of switches can be provided.

The function of the individual elements described is known per se, so that their interaction will only be briefly outlined:

If the identification transmitter 20 is inserted into the slot 18 or if the actuation unit 14 is acknowledged, data stored in the electronic unit 22 is read out from the transceiver unit 24 and checked in an electronic test unit (not shown), as to whether the data contains authorization data for operation of the vehicle. If it does, a circuit containing the switch 28 is activated for example or the switch 28 itself is powered up. If the actuation component 14 is now pressed into the housing 12 with the aid of the identification transmitter 20 or by pressing directly on the grip element 26, the switch 28 is actuated, which starts the engine of the motor vehicle for example. In this way the actuation component 14 forms a start/stop switch for operation of the engine or of the motor vehicle. If the actuation component is pressed once more while the engine is running, the engine is stopped.

If the transmitting/receiving unit 24 has a correspondingly long range, with this unit not having to be fitted directly in this case onto the housing or onto the actuation component 14, the data of the identification transmitter 20 can also be read out if this unit is not in the slot 18, but for example in the pocket of the motor vehicle operator's jacket. In this case the switch 28 is effectively switched if the authorization is positive, without the identification transmitter 20 having to be inserted into the actuation component 14. It is then possible to start the engine after a positive check on the identification transmitter 20 by pressing the actuation component 14 embodied overall as a pushbutton.

Thus the actuating module described can be used with identical parts both for systems which require the identification transmitter to be pressed in, and also with so-called PASE systems. Of course the identification transmitter 20 can also be used in the known way for access to the motor vehicle.

The device described can be modified in a variety of ways. For example different depths of insertion positions can be provided for the actuation component, to which different switches are assigned in each case, with which operating functions of the vehicle are switched. The actuation component 14 does not necessarily have to be embodied as a pushbutton; its cross-section can also be a circular cross shape so that different switches are actuated as the element is turned. In this case the actuation component preferably features a grip element protruding from the housing. Data communication between the electronic unit 22 and the transceiver unit 24 can be undertaken in a wide diversity of frequency ranges, including infrared for example.

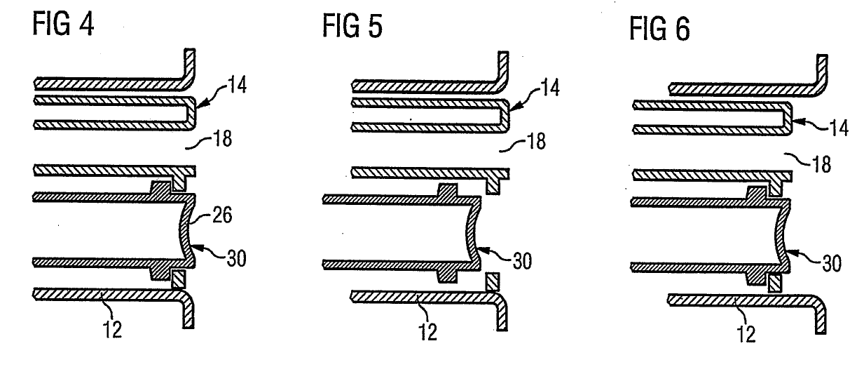

A modified embodiment of an actuation module is explained with reference to FIGS. 4 to 6. This differs from the previous FIGS. 1 to 3 in that the actuation component 14 is embodied in two parts and the grip element 26 embodied as a recess belongs to a linear movably-guided switching component 30 in the actuation component 14. The switch 28 (FIG. 1) can be actuated both just by pressing the switch component 30 and also by pressing the complete actuation component 14.

FIG. 5 shows the state of the actuation module when the grip element of the switch component 30 is pressed.

FIG. 6 shows the state of the actuation component when the switch component as a whole is pressed, for example by the identification transmitter not shown in FIG. 6 being pressed far enough into the slot 18 to take the actuation component 14 with it, which actuates the switch component 30.

The present invention is equally suitable for systems in which an identification transmitter is to be inserted into the slot of an actuation component as well as for PASE (Passive Safety Entry) systems, which frequently do without a slot insert.

What is claimed is:

1. An actuating module for a motor vehicle, comprising
a housing;
a movably-supported actuation component within a frontal opening of the housing, which can be moved manually by means of a front actuation surface serving as a grip element against an opposing force from a rest position into the housing, and after activation of at least one operating switch for a corresponding operating function returns to its rest position;
wherein the actuation component comprises a slot for insertion of an electronic identification device and the actuation component can also be moved without the identification device being inserted,
and wherein the actuation component consists of two part components which fit inside each other, of which one has the slot for the identification device and is mechanically coupled with the other subcomponent embodied as a switching component such that the other part component can be moved independently of the one part component by means of the actuation surface serving as a grip element.

2. The actuating module according to claim 1, wherein the at least one operating switch can be switched by each of the two subcomponents.

3. The actuating module according to claim 1, wherein different operating switches can be switched with the two subcomponents.

4. The actuating module according to claim 1, wherein the operating switch can be activated by interrogating the identification data for an identification device located outside the slot.

5. The actuating module according to claim 1, wherein the actuating module comprises an electronic communication unit for interrogating identification data elements when an identification device is inserted into the slot.

6. The actuating module according to claim 1, wherein the operating switch is an engine start/stop switch.

7. An actuating module for a motor vehicle, comprising
a housing;
a movably-supported actuation component within a frontal opening of the housing, which can be moved manually from a first to a second position;
wherein the actuation component comprises a slot for insertion of an electronic identification device and wherein the actuation component can be moved with or without the identification device being inserted,
and wherein the actuation component consists of two parts which fit inside each other, of which one part comprises the slot for the identification device and is mechanically coupled with the other subcomponent embodied as a switching component such that the other part can be moved independently of the one part component by means of the actuation surface serving as a grip element.

8. The actuating module according to claim 7, wherein the at least one operating switch can be switched by each of the two subcomponents.

9. The actuating module according to claim 7, wherein different operating switches can be switched with the two subcomponents.

10. The actuating module according to claim 7, wherein the operating switch can be activated by interrogating the identification data for an identification device located outside the slot.

11. The actuating module according to claim 7, wherein the actuating module comprises an electronic communication unit for interrogating identification data elements when an identification device is inserted into the slot.

12. The actuating module according to claim 7, wherein the operating switch is an engine start/stop switch.

13. An actuating module for a motor vehicle, comprising
a housing;
a movably-supported actuation component within a frontal opening of the housing, which can be moved manually from a first to a second position;
wherein the actuation component comprises a slot for insertion of an electronic identification device and wherein the actuation component can be moved with or without the identification device being inserted,
and wherein the actuation component consists of two parts which fit inside each other, of which one part comprises the slot for the identification device and is mechanically coupled with the other subcomponent embodied as a switching component such that the other part can be moved independently of the one part component by means of the actuation surface serving as a grip element, and
an electronic communication unit for interrogating identification data elements when an identification device is inserted into the slot.

14. The actuating module according to claim 13, wherein the at least one operating switch can be switched by each of the two subcomponents.

15. The actuating module according to claim 13, wherein different operating switches can be switched with the two subcomponents.

16. The actuating module according to claim 13, wherein the operating switch can be activated by interrogating the identification data for an identification device located outside the slot.

17. The actuating module according to claim 13, wherein the operating switch is an engine start/stop switch.
